(19) United States
(12) Patent Application Publication
(10) Pub. No.: US 2015/0247514 A1
(43) Pub. Date: Sep. 3, 2015

(54) CYLINDER DEVICE

(71) Applicant: Komatsu Ltd., Tokyo (JP)

(72) Inventors: Daisaku Isobe, Koriyama-shi (JP); Atsushi Satou, Koriyama-shi (JP); Jumpei Hayakawa, Koriyama-shi (JP)

(73) Assignee: KOMATSU LTD., Tokyo (JP)

(21) Appl. No.: 14/352,487

(22) PCT Filed: Dec. 19, 2013
(86) PCT No.: PCT/JP2013/084150

§ 371 Date: Apr. 17, 2014

(51) Int. Cl. F15B 15/28; F15B 15/14

(52) U.S. Cl. CPC F15B 15/2815; F15B 15/1428; F15B 15/1452; F15B 2211/60

(57) ABSTRACT

A cylinder device includes a cylinder head, a piston rod, a stroke detection unit that is provided in a housing chamber so as to open to a center hole of the cylinder head and outputs a detection signal corresponding to a stroke of the piston rod relative to the cylinder head, two bearing members that are installed along a longitudinal direction of the piston rod so as to sandwich the housing chamber in the center hole of the cylinder head, and a sealing system that is configured in a portion corresponding to a distal end side of the piston rod compared with the bearing members in the center hole of the cylinder head, and the piston rod is supported by the cylinder head via the two bearing members.

### FIELD

The present invention relates to a cylinder device and, more particularly, to a cylinder device provided with a stroke detection unit for outputting a detection signal corresponding to the stroke of a piston rod.

### BACKGROUND

Some of cylinder devices, in which a piston rod carries out a stroke movement relative to a cylinder tube, are provided with a stroke detection unit for detecting the stroke of the piston rod. The stroke detection unit, which is mounted on a cylinder head provided in the open end portion of the cylinder tube, is configured to output a detection signal corresponding to the stroke of the piston rod when the piston rod carries out a stroke movement relative to the cylinder head.

In the cylinder device described in Patent Literature 1, for example, a piston rod is provided with magnetic scales at predetermined intervals, and, a cylinder head is provided with a stroke detection unit having a magnetic sensor for detecting the magnetic scales of the piston rod. When the piston rod carries out a stroke movement in the cylinder device, the distance in the longitudinal direction between the magnetic sensor and the magnetic scale of the piston rod changes sequentially, and the magnetic sensor will output a detection signal corresponding to the stroke amount of the piston rod.

In the cylinder device described in Patent Literature 2, a cylinder head is provided with a sensor roller that rotates depending on the stroke of a piston rod as well as a stroke detection unit having a rotation sensor for detecting the rotation of the sensor roller. When the piston rod carries out a stroke movement in the cylinder device, the sensor roller rotates therewith and the rotation sensor for detecting the rotation of the sensor roller will output a detection signal corresponding to the stroke amount of the piston rod.

### CITATION LIST

### Patent Literature

Patent Literature 1: Unexamined Japanese Utility Model No. 64-3127

Patent Literature 2: Japanese Laid-open Patent Publication No. 2007-333626

### SUMMARY

### Technical Problem

Some of cylinder devices are used as a hydraulic cylinder device for operating a working machine such as a boom, an arm, a bucket, a blade in construction machinery. The main task of a construction machine is to excavate and transport sediment at a construction site, where use environment is harsh due to a lot of dust, etc. in many cases. Therefore, a cylinder device of this type is generally configured such that a sealing system, which is provided with a seal member such as a dust seal, a rod packing in the portion corresponding to the distal end side of a piston rod in the center hole of a cylinder head, prevents foreign matter such as dust and water from entering the interior from a gap between the cylinder head and the piston rod.

Here, as illustrated in FIG. 4-1, a piston rod 1 is slidably supported against a cylinder tube 5 by a bearing member 2a of a piston 2 provided in the proximal end portion of a piston rod 1 and a bearing member 4 of a cylinder head 3. As illustrated in this figure, when the piston rod 1 is positioned on the contraction side with respect to the cylinder tube 5, the mutual distance between the bearing member 2a of the piston 2 and the bearing member 4 of the cylinder head 3 is elongated, and the distance from the bearing member 4 of the cylinder head 3 to the distal end portion of the piston rod 1 is shortened. Therefore, even if an external force (arrow X) is applied on the distal end portion of the piston rod 1 from its periphery, the central axis of the piston rod 1 is less likely to be inclined relative to the cylinder tube 5 and the central axis of the center hole of the cylinder head 3.

However, as illustrated in FIG. 4-2, when the piston rod 1 is moved to the extension side with respect to the cylinder tube 5, the mutual distance between the bearing member 2a of the piston 2 and the bearing member 4 of the cylinder head 3 is shortened according to the stroke, and the distance from the bearing member 4 of the cylinder head 3 to the distal end portion of the piston rod 1 is elongated. Therefore, if an external force (arrow X) is applied on the distal end portion of the piston rod 1 from its periphery with the piston rod 1 positioned on the extension side with respect to the cylinder tube 5, the central axis of the piston rod 1 can be inclined relative to the cylinder tube 5 and the central axis of the center hole of the cylinder head 3 as illustrated by two-dot chain line in FIG. 4-2.

As described above, the cylinder head 3 provided with a stroke detection unit 6 is mounted on the open end portion of the cylinder tube 5. Thus, if the central axis of the piston rod 1 is inclined relative to the cylinder tube 5 and the central axis of the center hole of the cylinder head 3, the position of the piston rod 1 relative to the stroke detection unit 6 will also vary in the circumferential direction with respect to the center of inclination, and this may affect the detection result by the stroke detection unit 6.

In addition, a sealing system 7 provided in the center hole of the cylinder head 3 above works effectively if the piston rod 1 is positioned on the same central axis as the cylinder tube 5, while a gap may be partially formed between the sealing system 7 and the piston rod 1 with the central axis of the piston rod 1 inclined relative to the cylinder tube 5 and the central axis of the center hole of the cylinder head 3. Therefore, when work is carried out in such a manner that a bucket and a blade are soaked in water, for example, water enters the interior through a gap produced between the cylinder head 3 and the piston rod 1 and further reaches a housing chamber 3a from the opening of the center hole so that this may greatly affect the detection result by the stroke detection unit 6 in such a manner that an electronic circuit for outputting a detection signal is short-circuited and rust occurs in the bearing unit of a sensor roller.

An object of the present invention, which has been made in view of the above circumstances, is to provide a cylinder device capable of accurately detecting the stroke of a piston rod, even for use to be soaked in water.

### Solution to Problem

To achieve the above-described object, a cylinder device according to the present invention includes: a cylinder head that is provided in an open end portion of a cylinder tube; a piston rod that is slidably inserted into a center hole of the cylinder head and includes a piston at a proximal end portion positioned within the cylinder tube, the piston rod being stroked through the center hole of the cylinder head along a longitudinal direction of the piston rod; a stroke detection unit that is provided in a housing chamber so as to open to the center hole of the cylinder head and outputs a detection signal corresponding to a stroke of the piston rod relative to the cylinder head; two bearing members that are installed along the longitudinal direction of the piston rod so as to sandwich the housing chamber in the center hole of the cylinder head; and a sealing system that is configured in a portion corresponding to a distal end side of the piston rod compared with the bearing members in the center hole of the cylinder head, and the piston rod is supported by the cylinder head via the two bearing members.

Moreover, in the above-described cylinder device according to the present invention, the cylinder head includes: a head body that is mounted on the open end portion of the cylinder tube; and a housing that includes the housing chamber and is mounted on an end face of the head body, and the center hole of the head body and the center hole of the housing are provided with the respective bearing members.

Moreover, in the above-described cylinder device according to the present invention, the two bearing members are cylindrical sliding bearing members and each of which slidably abuts on an outer peripheral surface of the piston rod.

Moreover, in the above-described cylinder device according to the present invention, the sealing system includes: a rod packing that functions to prevent liquid from entering the bearing members between the piston rod and the rod packing itself; and a dust seal that is disposed in the portion corresponding to the distal end side of the piston rod compared with the rod packing and functions to prevent dust from entering the bearing members between the piston rod and the dust seal itself.

Moreover, in the above-described cylinder device according to the present invention, the stroke detection unit includes: a sensor roller that is rotatably disposed within the housing chamber in such a manner as to be allowed to abut against the outer peripheral surface of the piston rod through a peripheral surface of the sensor roller; a pressure spring that biases the peripheral surface of the sensor roller toward the piston rod; and a rotation sensor that outputs a detection signal corresponding to a direction and amount of rotation of the sensor roller associated with the stroke of the piston rod.

### Advantageous Effects of Invention

According to the present invention in which bearing members are provided at two locations along the longitudinal direction in the center hole of a cylinder head, the central axis of a piston rod will not be inclined relative to the central axis of the center hole of the cylinder head regardless of the stroke position of a piston rod, and thereby a sealing system works effectively at all times. Furthermore, since a stroke detection unit is mounted between two bearing members, a stroke can be detected without being affected by inclination of the piston rod. This results in that the stroke detection unit can detect the stroke of the piston rod accurately and reliably without fear that water will enter the interior, even for use in water.

### BRIEF DESCRIPTION OF DRAWINGS

FIG. 1 is a cross-sectional view of a cylinder device of an embodiment of the present invention.

FIG. 2 is an enlarged cross-sectional view illustrating the main part of the cylinder device illustrated in FIG. 1.

FIG. 3 is a cross-sectional view taken along line A-A in FIG. 1.

FIG. 4-1 is a cross-sectional view of a typical cylinder device when a piston rod is positioned on the contraction side with respect to a cylinder tube.

FIG. 4-2 is a cross-sectional view of the cylinder device illustrated in FIG. 4-1 when the piston rod is positioned on the extension side with respect to the cylinder tube.

### DESCRIPTION OF EMBODIMENTS

Preferred embodiments of a cylinder device according to the present invention will now be described in detail with reference to the accompanying drawings.

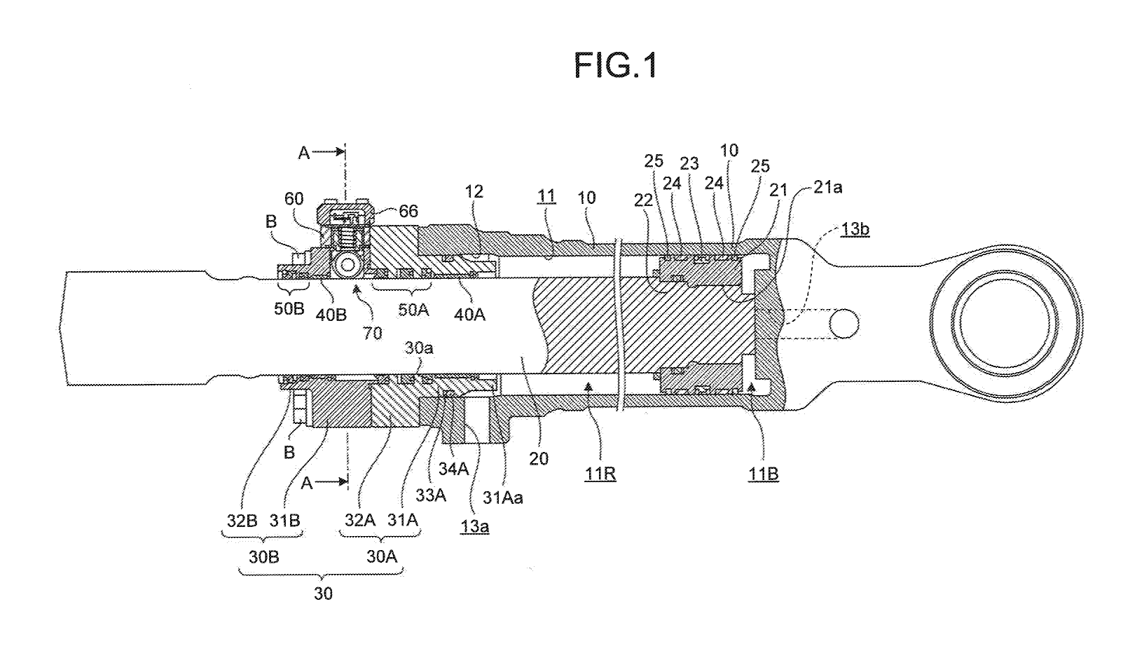

FIGS. 1 to 3 illustrate a cylinder device of the embodiment of the present invention. The cylinder device illustrated here, which is used, although not illustrated in the figures, as a hydraulic cylinder device for operating a working machine such as a boom, an arm, a bucket, a blade in construction machinery, is provided with a cylinder tube 10.

The cylinder tube 10, which defines the outer shell of a hydraulic cylinder device as illustrated in FIG. 1, has a cylindrical shape having a cylinder bore 11 in the center. The cylinder bore 11 is a cavity having a circular cross section. The cylinder bore 11 is configured to have a substantially uniform internal diameter along its entire length. The proximal end of the cylinder tube 10 is closed, and the distal end of the cylinder tube 10 is opened. The cylinder tube 10 is provided with a large diameter portion 12 and two supply and discharge ports 13a, 13b. The large diameter portion 12 is an annular recess formed on the inner peripheral surface of the distal end side of the cylinder tube 10 so as to have a slightly larger inner diameter. The supply and discharge ports 13a and 13b, which allow the cylinder bore 11 to communicate with the outside, are formed in the proximal and distal end portions of the cylinder tube 10, respectively. In this embodiment, the supply and discharge port 13b on the proximal end portion is formed so as to communicate with the cylinder bore 11 in the bottom wall of the cylinder tube 10, and the supply and discharge port 13a in the distal end portion is formed in the peripheral wall of the cylinder tube 10 so as to communicate with the cylinder bore 11 through the large diameter portion 12.

The cylinder bore 11 of the cylinder tube 10 is provided with a piston rod 20. The piston rod 20, which is a columnar member having a smaller diameter than the cylinder bore 11, is provided with a piston 21 at the proximal end portion. The piston 21, which is a cylindrical shape having a larger diameter than the piston rod 20 and a smaller longitudinal dimension than that of the cylinder bore 11, is threadedly engaged with the proximal end portion of the piston rod 20 through a rod mounting hole 21a formed in the center. The rod mounting hole 21a of the piston 21 facing the outer peripheral surface of the piston rod 20 is provided with an O-ring 22. The outer peripheral surface of the piston 21 is provided with a piston ring 23 slidably abutting on the inner peripheral surface of the cylinder bore 11, and each of both sides of the piston ring 23 is successively provided with a bearing member 24 and a guard ring 25.

In addition, the cylinder tube 10 is provided with a cylinder head 30. The cylinder head 30 has a center hole 30a in the center and is fixed to the distal end portion of the cylinder tube 10 with the piston rod 20 extending through the center hole 30a. In this embodiment, the cylinder head 30 includes a head body 30A mounted on the distal end portion of the cylinder tube 10 and a housing 30B mounted on the distal end portion of the head body 30A.

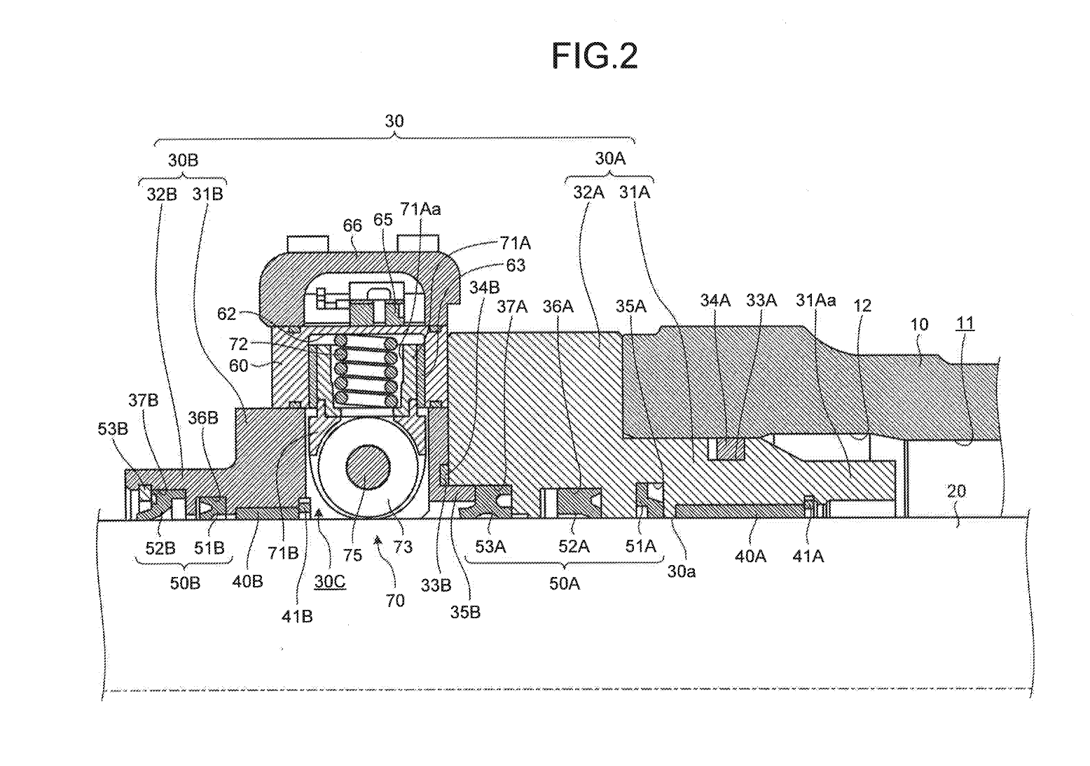

As illustrated in FIG. 2, the head body 30A of the cylinder head 30 is made by integrally forming an insertion portion 31A having an outer diameter that can be inserted into the cylinder bore 11 of the cylinder tube 10 and a body base 32A having an outer diameter larger than the cylinder bore 11. The outer peripheral surface of the insertion portion 31A is provided with an annular seal mounting groove 33A. The head body 30A is disposed at the distal end portion of the cylinder tube 10 through the body base 32A with an O-ring 34A mounted on the seal mounting groove 33A and with the insertion portion 31A inserted into the cylinder bore 11. As is also apparent from FIG. 1, a portion 31Aa of the insertion portion 31A opposite to the large diameter portion 12 of the cylinder tube 10 is formed such that the outer diameter thereof is smaller than the inner diameter of the cylinder bore 11, and a sufficient gap is left between the portion 31Aa and the large diameter portion 12 where the supply and discharge port 13a is opened.

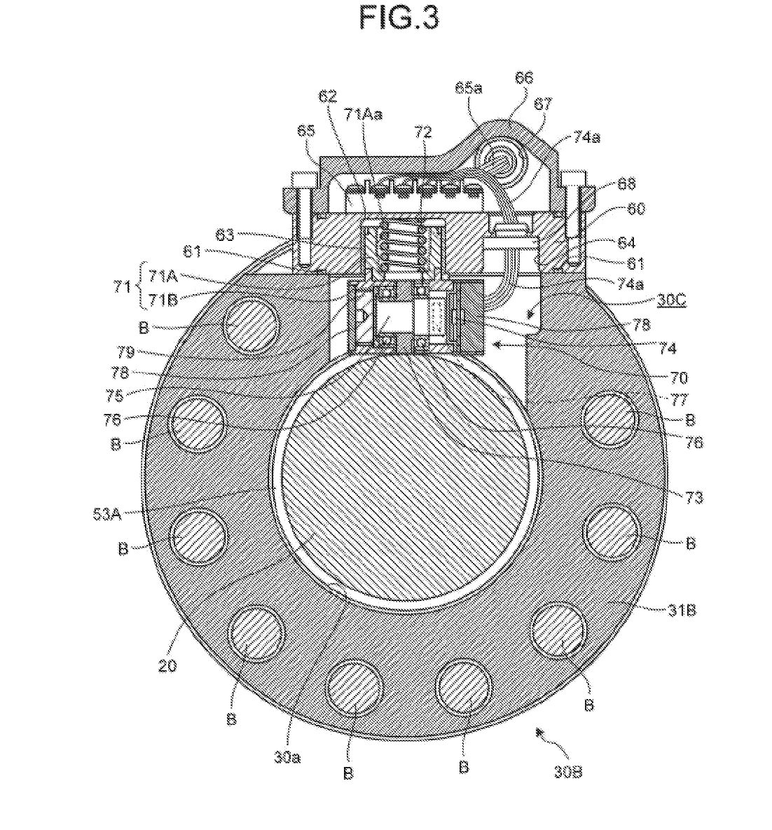

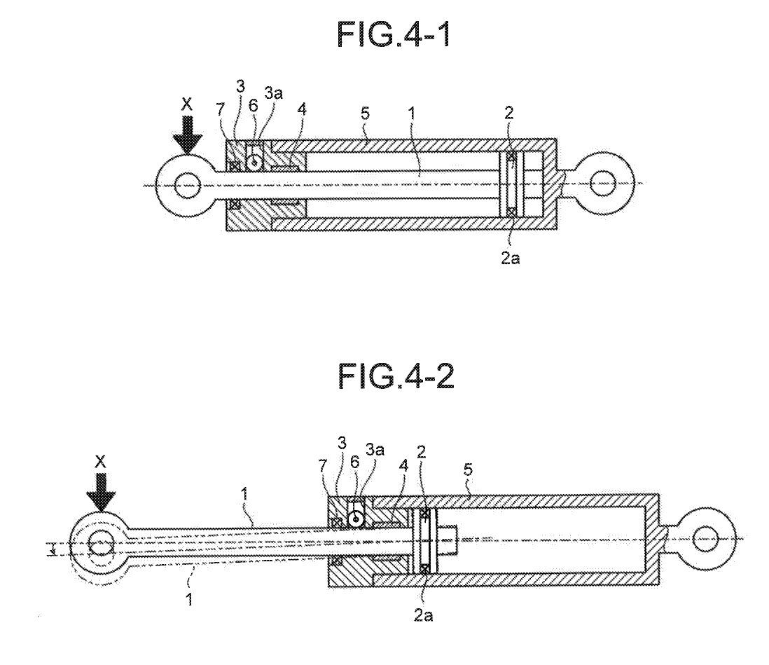

As illustrated in FIG. 1, the housing 30B of the cylinder head 30 is made by integrally forming a housing base 31B having an outer diameter substantially the same as that of the body base 32A of the head body 30A and a seal retaining portion 32B with an outer diameter smaller than that of the housing base 31B. As illustrated in FIG. 2, the end face of the housing base 31B is provided with an annular seal mounting groove 33B in the region of the outer periphery of the center hole 30a. The housing 30B, where the end face of the housing base 31B abuts against the end face of the body base 32A with an O-ring 34B mounted on the seal mounting groove 33B, is mounted on the cylinder tube 10 together with the head body 30A by a plurality of mounting bolts B as illustrated in FIG. 3. In this embodiment, the housing 30B is rigidly secured to the cylinder tube 10 together with the head body 30A by fastening the mounting bolt B at each of nine positions avoiding a housing chamber 30C described below.

As illustrated in FIG. 2, the head body 30A and the housing 30B are provided with a bearing member 40A and sealing system 50A and a bearing member 40B and sealing system 50B in the regions facing the piston rod 20 of their center holes 30a, respectively. The bearing members 40A, 40B, which are sliding bearing members referred to as “bush”, has a cylindrical shape that slidably abuts on the outer peripheral surface of the piston rod 20. The head body 30A is provided with a bearing member (hereinafter referred to an “inner bearing member 40A” for identification) on the inner peripheral surface of the insertion portion 31A, and the housing 30B is provided with a bearing member (hereinafter referred to an “outer bearing member 40B” for identification) in the region close to the seal retaining portion 32B on the inner peripheral surface of the housing base 31B. Note that reference numerals 41A and 41B in FIG. 2 are snap rings mounted to prevent the removal of the bearing members 40A, 40B.

The sealing systems 50A and 50B, which individually provide the function to prevent the passage of liquid such as water or oil and the function to prevent the passage of foreign matter such as dust between the cylinder head 30 and the piston rod 20, are configured in the head body 30A and the housing 30B, respectively.

The sealing system 50A of the head body 30A is configured such that a buffer ring 51A, an inner rod packing 52A, and an inner dust seal 53A are successively arranged along the longitudinal direction from the region close to the inner bearing member 40A in the direction toward the housing 30B in the center hole 30a. The buffer ring 51A, which prevents the high internal pressure of the cylinder bore 11 from acting on the inner rod packing 52A by making a sliding contact with the outer peripheral surface of the piston rod 20, is disposed in a ring groove 35A formed in the center hole 30a of the head body 30A. The inner rod packing 52A, which functions to prevent the passage of oil from the cylinder bore 11 to the housing 30B, is disposed in a packing receiving groove 36A formed in the center hole 30a of the head body 30A. The inner dust seal 53A, which functions to prevent the passage of foreign matter from the center hole 30a to the cylinder bore 11, is disposed in a seal receiving groove 37A formed in the center hole 30a of the head body 30A. As is also apparent from FIG. 2, the seal receiving groove 37A is formed to provide the end face of the head body 30A with an opening.

When the housing 30B is mounted on the end face of the head body 30A, a cylindrical lip portion 35B provided in the housing 30B is inserted into the seal receiving groove 37A, and thereby the lip portion 35B prevents the removal of the inner dust seal 53A.

The sealing system 50B of the housing 30B is configured such that an outer rod packing 51B and an outer dust seal 52B are successively arranged along the longitudinal direction from the region close to the outer bearing member 40B toward the end of the piston rod 20 in the center hole 30a. The outer rod packing 51B, which functions to prevent the passage of water to the outer bearing member 40B in the center hole 30a, is disposed in a packing receiving groove 36B formed in the center hole 30a of the housing 30B. The outer dust seal 52B, which functions to prevent the passage of foreign matter to the outer bearing member 40B in the center hole 30a, is disposed in a seal receiving groove 373 formed in the center hole 30a of the housing 30B. Note that reference numeral 53B in FIG. 2 is a snap ring mounted on the seal receiving groove 37B to prevent the removal of the outer dust seal 52B.

The housing 30B of the cylinder head 30 is also provided with a housing chamber 30C. As illustrated in FIGS. 2 and 3, the housing chamber 30C is a cavity provided in the housing base 31B and its end on the center side is open into the center hole 30a of the housing 30B, while the opening on the outer peripheral side is closed by a unit block 60 mounted on the outer peripheral surface of the housing base 313. A seal member 61 for ensuring water tightness is interposed between the unit block 60 and the housing 30B. As is also apparent from FIG. 2, the location where the housing chamber 30C is open in the center hole 30a of the housing 30B is the region between the inner dust seal 53A disposed in the head body 30A and the outer bearing member 40B installed in the housing 30B.

The housing chamber 30C of the housing 30B is provided with a stroke detection unit 70. The stroke detection unit 70, which detects the stroke of the piston rod 20 relative to the cylinder head 30 to output a detection signal according to the result of the detection as an electrical signal, is provided with a unit casing 71 in the housing chamber 30C. The unit casing 71 is adapted to have a slide guide portion 71A and a roller support portion 71B.

The slide guide portion 71A is a columnar member having a circular cross section and provided with a spring receiving portion 71Aa in its center. The slide guide portion 71A is slidably inserted into a guide hole 62 formed in the unit block 60 through a casing bearing member 63 with a pressure spring 72 received in the spring receiving portion 71Aa. The guide hole 62 formed along the radial direction of the piston rod 20 and circular in cross-section allows the slide guide portion 71A to be moved in the direction towards and away from the piston rod 20. The pressure spring 72 is a coil spring, which is interposed between the unit block 60 and the slide guide portion 71A and functions to constantly pressure the slide guide portion 71A against the unit block 60 along the direction toward the piston rod 20.

As illustrated in FIG. 3, the roller support portion 71B is a cylindrical member extending from the end of the slide guide portion 71A toward the radial direction of the slide guide portion 71A. Although not illustrated in the figure, a detent is provided between the unit block 60 and the roller support portion 71B such that the roller support portion 71B maintains a constant orientation perpendicular to the longitudinal direction of the piston rod 20. The roller support portion 71B is provided with a sensor roller 73 and a magnetic detection sensor 74.

The sensor roller 73 has a large-diameter disk portion provided in the center portion of a support shaft 75 so as to be rotated integrally with the support shaft 75. The sensor roller 73 is rotatably supported by the roller support portion 71B through roller bearings 76 mounted on both end portions of the support shaft 75 with the support shaft 75 along the longitudinal direction of the roller support portion 71B. As is also apparent from FIG. 3, a portion opposite to the piston rod 20 of the outer peripheral surface of the sensor roller 73 protrudes slightly outwardly from the outer peripheral surface of the roller support portion 71B, the sensor roller 73 being pressed to the outer peripheral surface of the piston rod 20 through the center hole 30a of the cylinder head 30 by the force of the pressure spring 72 above. Although not illustrated in the figure, the present embodiment uses the roller bearings 76 referred to as “sealed bearings” provided with a seal member for sealing the gap between an outer ring and an inner ring.

The magnetic detection sensor 74 detects a change in magnetic force in a non-contact manner and outputs the result of the detection as an electrical signal. The magnetic detection sensor 74 is attached to the unit casing 71 in proximity to an end face of the support shaft 75. An end close to the magnetic detection sensor 74 of the support shaft 75 is provided with a permanent magnet 77. Although not illustrated in the figure, the permanent magnet 77 of the support shaft 75 is provided such that magnetic force detected by the magnetic detection sensor 74 varies depending on the direction and amount of rotation when the support shaft 75 rotates.

Mold resin 78 is filled in the end provided with the magnetic detection sensor 74 of the unit casing 71, thereby ensuring the waterproofness of the magnetic detection sensor 74. A cable 74a extended from the magnetic detection sensor 74 protrudes from the mold resin 78 to the housing chamber 30C, is then led out of the housing chamber 30C through an insertion hole 64 formed in the unit block 60, and is connected to the terminal of a terminal block 65. The terminal block 65 is covered by a cover member 66, thereby ensuring water tightness as desired. A cable 65a extending from the terminal block 65 is led out from an outlet hole 67 of the cover member 66. The insertion hole 64 of the unit block 60 is provided with a grommet 68 to prevent the passage of water. A nut 79 is screwed on the other end of the unit casing 71 to apply a preload to the roller bearing 76. The mold resin 78 is filled in the outer end of the nut 79, thereby preventing water from entering the roller bearing 76.

In the hydraulic cylinder device configured as described above, the cylinder bore 11 of the cylinder tube 10 is partitioned into a rod-side pressure chamber 11R and a bottom-side pressure chamber 11B by the piston 21 as illustrated in FIGS. 1 and 2. Thus, when oil is alternately supplied from two supply and discharge ports 13a and 13b to the pressure chambers 11R and 11B, respectively, the piston rod 20 carries out a stroke movement relative to the cylinder tube 10 and allows the bucket for construction machinery to be operated as desired, for example.

While the piston rod 20 carries out a stroke movement relative to the cylinder tube 10, the sensor roller 73 pressed to the outer peripheral surface of the piston rod 20 is rotated depending on the stroke direction and stroke amount of the piston rod 20. This changes the magnetic force of the permanent magnet 77 detected by the magnetic detection sensor 74 and a detection signal corresponding to the direction and amount of rotation of the sensor roller 73 is output from the magnetic detection sensor 74. Thus, the stroke of the piston rod 20 relative to the cylinder head 30 can be detected on the basis of the detection signal.

Here, also in the hydraulic cylinder device described above, the piston rod 20 is slidably supported against the cylinder tube 10 by the bearing member 24 of the piston 21 mounted on the proximal end portion and the bearing members 40A, 40B of the cylinder head 30. Hence, when the piston rod 20 is positioned on the contraction side with respect to the cylinder tube 10, the mutual distance between the bearing member 24 of the piston 21 and the bearing members 40A, 40B of the cylinder head 30 is elongated, and the distance from the bearing members 40A, 40B of the cylinder head 30 to the distal end portion of the piston rod 20 is shortened. Therefore, even if an external force is applied on the distal end portion of the piston rod 20 from its periphery, the central axis of the piston rod 20 is unlikely to be inclined relative to the cylinder tube 10 and the central axis of the center hole of the cylinder head 30, and the sealing systems 50A, 50B described above work effectively. That is, the sealing system 50B of the housing 30B prevents the passage of foreign matter from the center hole 30a toward the outer bearing member 40B and the passage of water from the center hole 30a toward the outer bearing member 40B, between the piston rod 20 and the cylinder head 30. In addition, the sealing system 50A of the head body 30A prevents the passage of oil from the cylinder bore 11 toward the housing 30B and the passage of foreign matter from the center hole 30a toward the cylinder bore 11. Thus, even if a bucket and an arm work in such a manner that they are soaked in water, for example, no water can enter the interior of the cylinder tube 10 from between the cylinder head 30 and the piston rod 20.

in contrast, when the piston rod 20 is positioned on the extension side with respect to the cylinder tube 10, the mutual distance between the bearing member 24 of the piston 21 and the bearing members 40A, 40B of the cylinder head 30 is shortened according to the stroke, and the distance from the bearing members 40A, 40B of the cylinder head 30 to the distal end portion of the piston rod 20 is elongated.

However, the hydraulic cylinder device above has two bearing members 40A, 40B installed along the longitudinal direction of the center hole 30a of the cylinder head 30, resulting in that the hydraulic cylinder device supports the piston rod 20 substantially along the entire length from one bearing member 40A to the other bearing member 40B. Thus, it is unlikely that the central axis of the piston rod 20 will be inclined relative to the cylinder tube 10 and the central axis of the center hole of the cylinder head 30 by an external force even when the piston rod 20 is positioned on the extension side, and the two sealing systems 50A, 50B are adapted to work effectively. In addition, since the sensor roller 73 of the stroke detection unit 70 is disposed between the two bearing members 40A, 40B, the distance between the sensor roller 73 disposed between the two bearing members 40A, 40B and the piston rod 20 cannot change. This results in that, even if a bucket and an arm are used in water, no water can enter the housing chamber 30C of the cylinder head 30 and the stroke detection unit 70 can detect the stroke of the piston rod 20 accurately and reliably.

Although the embodiment described above illustrates a hydraulic cylinder device for operating the working machine of a construction machine, the present invention is not limited thereto, and the hydraulic cylinder device may also be configured as a cylinder device for other uses.

Further, the embodiment described above illustrates a cylinder device the cylinder head 30 of which is configured to be provided with the head body 30A and the housing 30B; however, the cylinder head of the present invention does not necessarily need to be provided with a plurality of members.

Additionally, while the embodiment described above illustrates the stroke detection unit 70 provided with the sensor roller 73 rotating through the stroke of the piston rod 20 and the magnetic detection sensor 74 for magnetically detecting the rotation of the sensor roller 73, the present invention may use other stroke detection units. For example, a sensor roller whose rotation is detected by an encoder may be used, and the stroke of a piston rod may be detected by detecting a magnetic scale provided with the piston rod using a magnetic detection sensor.

Still further, while the embodiment described above illustrates the sealing system 50B in which the outer rod packing 51B and the outer dust seal 52B are arranged along the longitudinal direction, the configuration of the sealing system is not limited thereto and it may only need at least an element to ensure water tightness. Note that while the embodiment described above is provided with the sealing system 50A between the housing chamber 30C and the inner bearing member 40A, the sealing system does not necessarily need to be provided between the housing chamber 30C and the inner bearing member 40A.

### REFERENCE SIGNS LIST

10 Cylinder Tube
20 Piston Rod
21 Piston
30 Cylinder Head
30A Head Body
30B Housing
30C Housing Chamber
30a Center Hole of Cylinder Head
40A, 40B Bearing Member
50B Sealing System
51B Outer Rod Packing
52B Outer Dust Seal
70 Stroke Detection Unit
71 Unit Casing
72 Pressure Spring
73 Sensor Roller
74 Magnetic Detection Sensor

1. A cylinder device comprising:
a cylinder head that is provided in an open end portion of a cylinder tube;
a piston rod that is slidably inserted into a center hole of the cylinder head and includes a piston at a proximal end portion positioned within the cylinder tube, the piston rod being stroked through the center hole of the cylinder head along a longitudinal direction of the piston rod;
a stroke detection unit that is provided in a housing chamber so as to open to the center hole of the cylinder head and outputs a detection signal corresponding to a stroke of the piston rod relative to the cylinder head;
two bearing members that are installed along the longitudinal direction of the piston rod so as to sandwich the housing chamber in the center hole of the cylinder head; and
a sealing system that is configured in a portion corresponding to a distal end side of the piston rod compared with the bearing members in the center hole of the cylinder head, wherein
the piston rod is supported by the cylinder head via the two bearing members.

2. The cylinder device according to claim 1, wherein the cylinder head comprises:
a head body that is mounted on the open end portion of the cylinder tube; and
a housing that includes the housing chamber and is mounted on an end face of the head body,
wherein the center hole of the head body and the center hole of the housing are provided with the respective bearing members.

3. The cylinder device according to claim 1, wherein the two bearing members are cylindrical sliding bearing members and each of which slidably abuts on an outer peripheral surface of the piston rod.

4. The cylinder device according to claim 1, wherein the sealing system comprises:
a rod packing that functions to prevent liquid from entering the bearing members between the piston rod and the rod packing itself; and
a dust seal that is disposed in the portion corresponding to the distal end side of the piston rod compared with the rod packing and functions to prevent dust from entering the bearing members between the piston rod and the dust seal itself.

5. The cylinder device according to claim 1, wherein the stroke detection unit comprises:
a sensor roller that is rotatably disposed within the housing chamber in such a manner as to be allowed to abut against the outer peripheral surface of the piston rod through a peripheral surface of the sensor roller;
a pressure spring that biases the peripheral surface of the sensor roller toward the piston rod; and
a rotation sensor that outputs a detection signal corresponding to a direction and amount of rotation of the sensor roller associated with the stroke of the piston rod.
